(19) United States
(12) Patent Application Publication
(10) Pub. No.: US 2015/0297002 A1
(43) Pub. Date: Oct. 22, 2015

(54) Tool-less Reusable Hinged Wall Hanger

(71) Applicant: Joseph Long, Simpsonville, SC (US)

(72) Inventor: Joseph Long, Simpsonville, SC (US)

(21) Appl. No.: 14/752,929

(22) Filed: Jun. 27, 2015

Related U.S. Application Data
(63) Continuation of application No. 13/769,460, filed on Feb. 18, 2013.

(51) Int. Cl. A47G 1/16; F16B 2/10; F16M 13/02

(52) U.S. Cl. CPC A47G 1/1633; F16M 13/02; F16B 2/10

(57) ABSTRACT

A reusable wall anchor device comprised of an upper and lower panel held together by a hinge connection for facilitating the suspending of articles from wallboards without requiring a hollow void behind the wallboard. A load bearing shank extends from the front face of the lower panel for supporting an object to be carried by the device. An arcuate prong and tine extend from the rear faces of the panels providing clamping and shear support for the device when they are inserted into the wallboard. The anchor assembly requires no tools other than the human hand during installation and removal and upon removal leaves minimal disruption to the wallboard.

### CROSS REF

This is a continuation of application Ser. No. 13/769,460, Filed Feb. 18, 2013, now abandoned

### BACKGROUND OF THE INVENTION

The invention relates to the field of hangers, hooks, anchors, and the like for hanging and fixing objects on a wall

### REFERENCES

U.S. Pat. No. 1,295,734

U.S. Pat. No. 2,789,783

U.S. Pat. No. 3,219,302

U.S. Pat. No. 3,431,813

U.S. Pat. No. 4,009,634

U.S. Pat. No. 4,619,430

U.S. Pat. No. 5,028,030

U.S. Pat. No. 6,126,126

U.S. Pat. No. 6,478,273

2005 021 8284 A1

### BACKGROUND ART

A number of fasteners have been used in the past for securing or suspending articles on hollow walls for example dry walls or plasterboard walls. These walls are thin and produced out of powdery materials so that conventional fasteners such as screws, nails, etc. are ineffective in supporting all but the lightest of articles hung on the wall. Through the years the solution adopted to provide secure support for articles on such hollow walls has been the use of two part supports comprising a combination anchoring member and a conventional fastening member such as screw or bolt which is secured to the anchoring member once such member has been inserted in the hollow wall.

Typical fastening members of this type are described in the patent art exemplified by U.S. Pat. Nos. 1,295,734 3,431,813 and 4,009,634 among others. These various fastening members are inserted into the hollow wall usually by first drilling a hole through the wall sufficient to allow for insertion of the enclosing member and then inserting the anchoring member in the hole. Once the anchoring member is in place, a screw or bolt is employed to either expand a portion of the anchoring member in the wall or to deform the anchoring member so as to provide a back up plate like arrangement to spread the weight of an article hung on the wall over a larger surface. In both instances the anchoring member becomes for all practical purposes a permanent part of the wall as removal is difficult and results in damaging the wall.

Recently a variation of the type of fastener shown in U.S. Pat. No. 1,295,734 has appeared in which the fastener is equipped with a pointed end. Insertion is obtained by simply hammering the fastener into the wall somewhat similar to a nail. While this method eliminates the extra step of hole drilling it tends to damage the inner and thus invisible portion of the wall because of its rather wide cross section. This damage consists of the formation of a crater of unpredictable size around the anchoring member due to crumbling of the wall as the fastening member is forced through. Thus the wall is weakened in the immediate vicinity where a load will be applied. Such hangers provide very secure attachment but are relatively complicated with usually two or more moving parts and can be tedious to install and require tools. Also where there is a stud or no cavity behind the wallboard such connectors will not work.

Other gypsum wallboard connectors utilize an expanding cylinder or conical insert that provides significantly more surface area contact with the wallboard. These also utilize a plurality of components and take several distinct operations to install. If removed there is significant damage to the wallboard.

Use of curved anchors with no moving parts for attachment to wallboard have typically either required first creating a horizontal hole through the wallboard in a separate operation or utilize a pointed end that punctures the wallboard and extends essentially horizontally there through. Typically a pointed rigid wire prong pierces the wallboard into the cavity or hollow behind the wallboard having the wire curve upwardly and around to engage in inner surface of the wallboard thereby distributing the shear force to the liner on the second hidden surface of the wallboard.

U.S. Pat. No. 6,478,273 issued to McKeiernan Jr et al on Nov. 12, 2002 titled Wall Tack teaches an improved 3-prong wall tack for upholstered wall surface or the like. The tack incorporates two prongs with curves formed and pointed on the ends pointing orthogonally relative to the major surface of the tack body. The 90-degree bend is in a limited area approximately less than 50% of the expanded length of the prong medially between the point and the tack body. This is not identified or suggested for use on gypsum wallboard and the tight 90-degree turn would not be conducive to solid attachment in the core due to the disruption of the core. In the case of wallboard type of installation, the 3-prong wall tack would expectedly require a hollow or void behind the wallboard to accommodate the bent prongs.

U.S. Pat. No. 6,126,126 issued to McKeirnan Jr on Oct. 3, 2000 titled Tack with Three Prongs teaches a three prong tack having a rigid flat body with three round wire prongs extending from one surface with two of the prongs angled at less than 90 degrees from the body of the tack while the third prong is normal to the body of the tack. U.S. Pat. No. 4,619,430 issued to Hogg on Oct. 28, 1986 titled Picture Frame Hanger teaches a back plate with hook and wire attached to a hollow wall using a pointed wire in two preferred embodiments one arched the other straight bent. The arched embodiment results in the round wire point re-penetrating the surface opposite back plate. The second embodiment has a bent wire with the bend angle less than 90 degrees so that the wire tangentially engages interfaces with the opposite surface of the hollow wall. U.S. Pat. No. 2,789,783 issued to Jones on Jun. 1, 1953 titled Hanger teaches a formed wire hanger made of round wire with a swaged pointed end with the flat surface of the swag aligned orthogonally to the hollow plaster wall panel surface and contacting the wall panel surface at the swaged end. This has a similar pressure gradient problem as in previously noted patents and would only work on wallboard with a hollow or void behind it. In each case of prior art cited in this paragraph, the anchoring device requires a hollow section within the wall for the formed wire apparatus to reside. The anchors cited are made of round wire and either pointedly or tangentially interface with the hidden side of the wallboard panel both of which have a high stress concentration against the panel when the anchor is loaded. These hangers involve some intricate manipulation for attachment and removal.

Additional types of wall hangers or hooks that can be used to hang an object on a wall include devices such as U.S. Pat. No. 3,219,302 which discloses various wall hangers all which have in common a pointed end, a curved semi circular portion which is very similar to a right angle bend, a vertical leg connected to the send circular portion by a bend that is more gradual than a right angle bend, a horizontal portion connected to the vertical portion in a right angle bend, and an exterior vertical leg portion connected to the horizontal portion by a right angle bend. In inserting this hanger into a wall, the pointed end is pushed perpendicularly with a reciprocal twisting motion into the wall at the desired location. The point forms a hole through the wall and when the point reaches the interior side of the wall the semi circular portion is eased through the hole. However the near right angle shape of semi circular portion causes enlargement of the hole made through the wall by the point and in addition the tight angle between the vertical portion and the horizontal portion further enlarges the hole in the wall.

Furthermore the semi circular portion is free to slide up and down or sideways with the interior surface of the wall. It does not dig into the interior surface of the wall to result in tensioning those parts of the hanger extending between those points where it contacts the inner surface of the wall. While U.S. Pat. No. 3,219,302 speaks of a snap in action, the undue enlargement of the hole formed by the point when the semicircular portion and the right angle bend between horizontal and vertical portions are forced through the hole contribute very little resistance to keeping the hanger in a stable position. When an upward force is applied to the hook portion of the hanger it may become unstable. Any spring bias that is provided by the interior portions of this hanger tends to enable the pivoting of the horizontal portion in the wall such that a vertical portion and semi circular portion are urged away from the wall surface. This contributes to an unstable characteristic of this hanger such that upward forces accidentally applied to the exterior portions of the hanger will cause pivoting of the hanger in the hole and over a period of time will result in such ultimate enlargement of the hole as to allow the hanger to fail.

U.S. Pat. No. 5,028,030 discloses a picture hanger that can be used with pre existing holes having diameters up to about a quarter inch. Moreover U.S. Patent Application No 2005 021 8284 A1 discloses a monkey hook having a self boring tip for penetrating a drywall, a parabolic curve mid section producing a stable self locking mechanism to prevent unintended rotation, and an extended tilt back tip at the opposite end of this single wire design tilting back and away from the backing of a picture or other object. The aforementioned hangers only provide a relatively limited holding force. Further, since the hanger shall provide a self boring function in such a way that it can intersect a drywall without making use of additional tools, either the drywall has to be of a fragile and thin consistence or the diameter of the portion of the harmer being suitable for wall penetration has to be sufficiently small. In either configuration being suitable for a manual assembly i.e. without making use of additional tools the maximum load limit is fairly small.

In a combination with a rather large wire diameter and a fairly thick and or robust wall a force being necessary it order to insert the hanger into the wall typically exceeds a maximum force that can be provided manually without making use of tools. Another combination with a relatively thick or stable wall and a hanger being relatively small in diameter has the disadvantage that even though manual hanger insertion is possible, the hanger itself due to its small diameter does not provide a sufficiently large load limit. Another combination being suitable for manual assembly comprises a thin or a medium sized but fragile or soft wall and a hanger being relatively large in diameter. When the hanger in this combination is in its final assembly position in the wall due to the softness of the wall the hanger will carve or engrave into the wall in the direction of gravity hence in the direction opposite to the holding force provided by the hanger. The present embodiment provides a device which is easy to employ and which overcomes all the problems attendant the prior art.

### SUMMARY

The present embodiment serves to anchor appurtenances to a wall or surface and avoids the drawbacks found in the background art. In the present embodiment, a device is comprised of an upper flat panel and a lower flat panel joined together my means of a hinge connection. Protruding from the upper panel rear face is an arcuate shank or prong having a distal point. The upper panel rear face presents a flat surface which the arcuate prong extends directly initially perpendicularly and then sweeps downwardly with a radius of curvature. The radius of curvature of the prong in the embodiment is equal to the distance said curved member is located from the hinged connection. The upper panel is connected to the lower panel by means of a hinge connection allowing rotation. The lower panel exhibits a small boring extending completely through the lower panel and at a perpendicular orientation from the lower panel rear face. The boring acts as a sight aperture through which the device can be properly positioned at a desired location on a wall or surface. The embodiment also exhibits a tine or spike protruding perpendicularly from the lower panel rear face. An additional feature of the embodiment is a load bearing shank protruding perpendicularly from the lower panel front face from which objects may be suspended.

Utilizing the sight aperture of the embodiment, the device is positioned at the desired mounting location on the wall. Once location is achieved, pressure is applied horizontally to lower panel front face thereby forcibly driving the tine located on the lower panel rear face into the wallboard. Horizontal pressure is applied continuously until the tine penetrates the wallboard completely at which point the lower panel rear face contacts and engages the outer surface of the wall and rests flatly against the wall.

While the lower panel is held securely to the wall, force is applied perpendicularly to the upper panel front face. Due to the hinge connection of the embodiment joining the lower panel to the upper panel, as well as the now fixed location of the lower panel into the wall, the perpendicular force applied to the upper panel front face results in the upper panel rotating around the hinge connection. The force perpendicular to the upper panel front face continues, and thus the rotation continues, until the distal point of the arcuate prong makes contact with the outer surface of the wallboard. Further rotation of the top panel results in the prone penetrating the wallboard along the arcuate path of the prong until the upper panel rear face contacts and rests flatly against the outer surface of the wall. The resulting orientation of the features of the embodiment create physical conditions in which the device assembly is securely mounted to the wall. Mounting of the device thus completed, the load bearing shank extending from the lower panel front face is utilized for the purpose of suspending such household or office items not limited to shelving, pictures, frames, posters, racks, decorative items, window treatments, and operative devices such as clocks, speakers, and other electrical items.

A feature and advantage of the embodiment is that the device defies the reasonable expectation that a hinged device comprising of a tine and a downwardly extending arcuate prong rotated into a wall material would provide insignificant weight carrying capability. A feature and advantage of the embodiment is that the device does not require a clearance void behind the wallboard on which it is mounted and therefore can be mounted anywhere on the wallboard regardless of stud location. A feature and advantage of the embodiment is that the weight of the attached appurtenance effectively provides dual moments which operate rotationally around the hinge connection and opposite of each other creating a clamping force securing the embodiment to the wall on which it is anchored.

A feature and advantage of the embodiment is that gravity effectively secures the device and appurtenance in place. An advantage of the embodiment is that the device is readily and easily installed into, and removed from, wallboard and in particular gypsum based wallboard and does not require any tools for installation or removal. A feature and advantage of the embodiment is that there is minimal disruption of the core of wallboard when inserted therein. The smooth arcuate shape that encompasses the extended length of the arcuate prong creates a path defined by the arcuate shape and does not crush the core outside the actual path. In alternative embodiments the device includes a second arcuate shank or prong extending from the upper panel having similar geometry, location, and characteristics of the original prong.

Further objects and other features of the device will become apparent from the non restrictive description that follows the described embodiment having reference to the listed drawings.

### LIST OF REFERENCE NUMERALS

10. Upper Panel
12. Hinge Connection
14. Lower Panel
16. Sight Aperture
18. Tine
20. Load Bearing Shank
22a. Arcuate Prong
22b. Secondary Arsenate Prong
36. Wallboard
38. Upper Panel Front Face
40. Upper Panel Rear Face
42. Lower Panel Front Face
44. Lower Panel Rear Face

### BRIEF DESCRIPTION OF DRAWINGS

FIG. 1-A contains a perspective view showing the rear side of the embodiment.

FIG. 1-B contains a perspective view showing the front side of the embodiment.

FIG. 2-A contains a perspective view illustrating the rear side of an alternative embodiment exhibiting an additional arcuate prong.

FIG. 2-B contains a perspective view illustrating the front side of an alternative embodiment exhibiting an additional arcuate prong.

FIG. 3 illustrates a profile view of the embodiment and cross sectional view of typical wallboard as well as depicting the use of the sight aperture of the embodiment.

FIG. 4 illustrates a profile view of the embodiment and cross sectional view of typical wallboard as well as depicting the tine of the lower panel of the embodiment partially penetrating the wallboard.

FIG. 5 illustrates a profile view of the embodiment and cross sectional view of typical wallboard as well as depicting the tine of the lower panel of the embodiment fully penetrating the wallboard.

FIG. 6 illustrates a profile view of the embodiment and cross sectional view of typical wallboard as well as depicting the rotational behavior of the upper panel relative to the hinge connection when force is applied perpendicularly to the front face of the upper panel of the embodiment.

FIG. 7 illustrates a profile view of the embodiment and cross sectional view of typical wallboard as well as depicting the penetrating path of the arcuate prong following the radius of curvature of the arcuate prong when force is applied perpendicularly to the front face of the upper panel of the embodiment resulting in rotation of the upper panel.

FIG. 8 illustrates a profile view of the embodiment and cross sectional view of typical wallboard as well as depicting the final geometry of all features of the embodiment resulting in the embodiment being fully anchored to the section of wallboard.

### DETAILED DESCRIPTION OF THE DRAWINGS

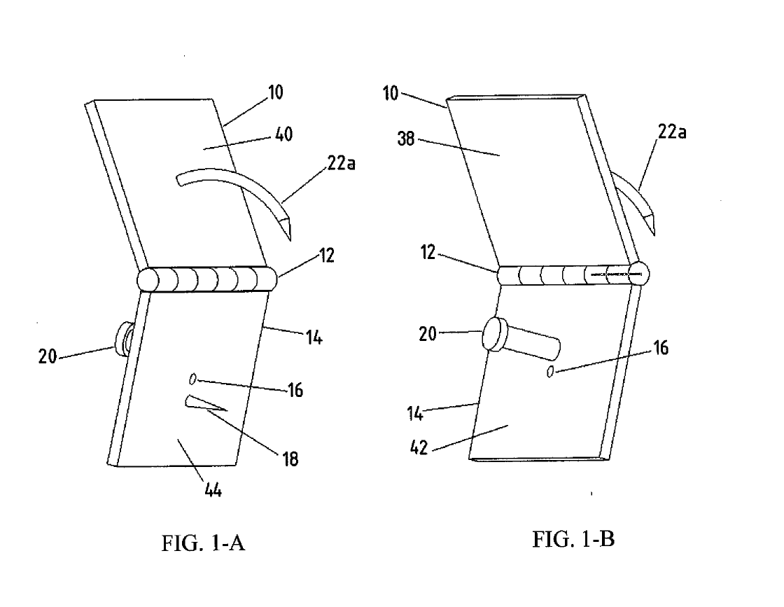

An embodiment of the device is illustrated in FIG. 1-A and FIG. 1-B. The embodiment generally resembles a common door/butt hinge with a arcuate prong, tine, and shank extending from the faces of the hinge.

More specifically, the embodiment is comprised of an upper flat panel 10 and a lower flat panel 14 joined together my means of a hinge connection 12. Protruding from the upper panel rear face 40 is an arcuate shank 22a or prong having a distal point. The upper panel rear face 40 presents a flat surface which the arcuate prong 22a extends directly initially perpendicularly and then sweeps downwardly with a radius of curvature.

The radius of curvature can be held constant or vary along the length of the arcuate prong 22a and is generally equal to or less than the thickness of the wallboard to which the device would be attached. Due to the radius of curvature of the arcuate prong 22a, the embodiment does not require a clearance void behind the wallboard on which the device would be mounted. The embodiment therefore can be mounted anywhere on wallboard regardless of stud location which is a feature and advantage of the embodiment.

The upper panel 10 is connected to the lower panel 14 by means of a hinge connection 12 allowing rotation. A feature of the lower panel 14 is a small boring extending completely through the lower panel 14 and at a perpendicular orientation from the lower panel rear face 44. The boring acts as a sight aperture 16. Utilizing the sight aperture 16, the embodiment can be properly positioned at a desired location on a wall or surface.

The embodiment also exhibits a tine 18 protruding perpendicularly from the lower panel rear face 44. The tine 18 is of similar geometry and dimensions of an office wall tack and wires the same force to penetrate wallboard as a tack Protruding perpendicularly from the lower panel front face 42 is a load bearing shank 20 from which objects may be suspended.

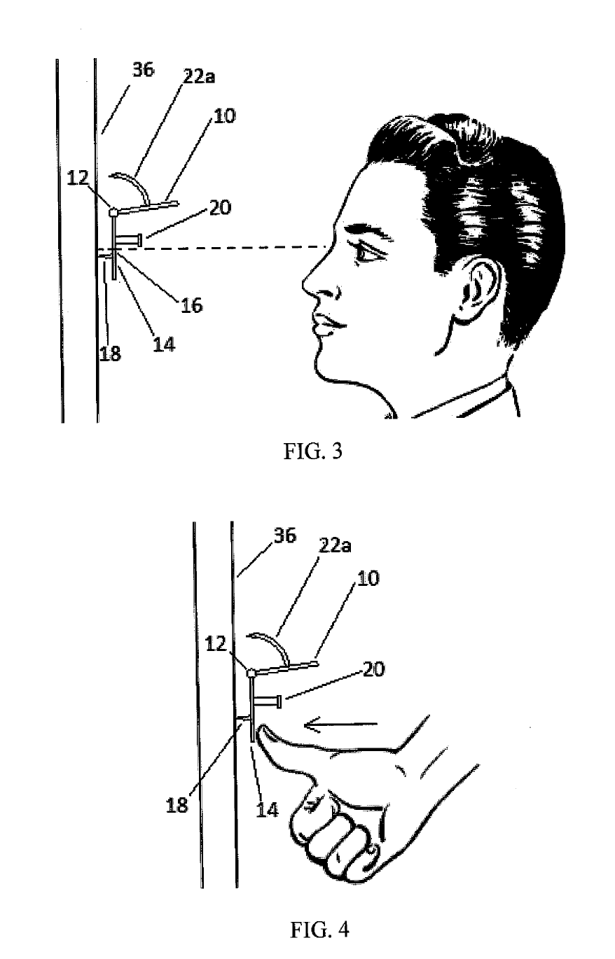

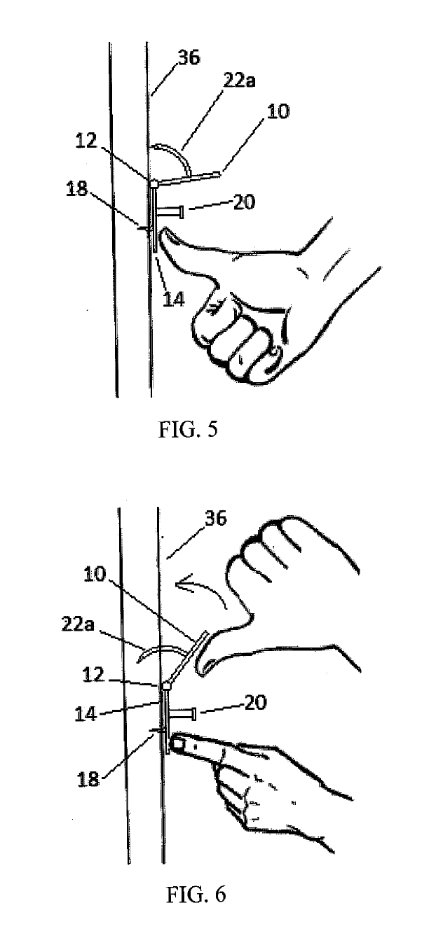

FIG. 3 illustrates the utilization of the sight aperture 16 during the installation process of the embodiment onto a cross section of wallboard 36. Looking through the sight aperture 16 allows a specific position to be located on the wallboard 36. Once proper positioning has been accomplished, pressure is applied horizontally to the lower panel front face 42. This pressure forces the tine 18 located on the lower panel rear face 44 into the wallboard 36 as shown in FIG. 4. The pressure is applied continuously until the tine 18 penetrates the wallboard 36 completely illustrated in FIG. 5.

While the lower panel 14 is held securely to the wallboard 36 by the tine 18, force is applied perpendicularly to the upper panel front face 38. The perpendicular force applied to the upper panel front face 38 results in the upper panel 10 rotating around the hinge connection 12 due to the fixed location of the lower panel 14 into the wallboard 36. The rotation of the upper panel 10 continues until the distal point of the arcuate prong 22a penetrates into the wallboard 36 as illustrated in FIG. 6. Further rotation of the top panel 10 results in the remaining section of the arcuate prong 22a penetrating the wallboard 36 through the boring created by the distal point of the arcuate prong 22a.

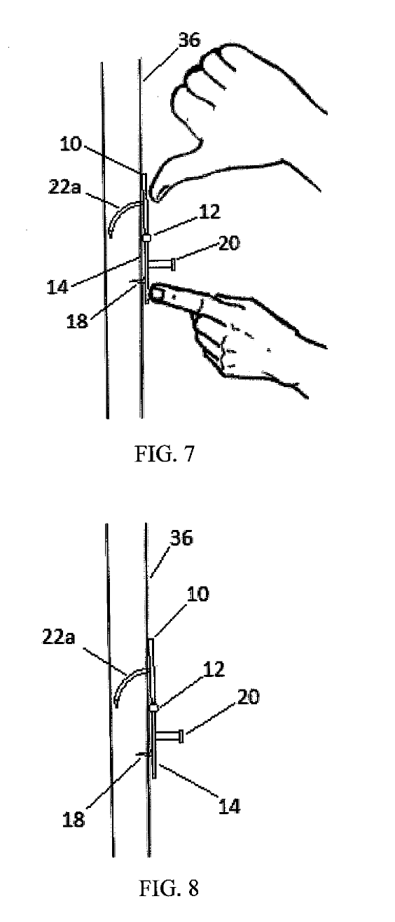

Since the entire arcuate prong 22a penetrates the wallboard 36 through only one entry point, the arcuate prong 22a results in minimal disruption of the wallboard 36 when inserted therein. The radius of curvature of the arcuate prong 22a dictates the path of penetration of the arcuate prong 22a into the wallboard 36. The distance of the arcuate prong 22a relative to the hinge connection 12 also influences the path of penetration of the arcuate prong 22a into the wallboard 36. The arcuate prong 22a penetrates the wallboard 36 until the upper panel rear face 40 contacts the outer surface of the wallboard 36 as shown in FIG. 7.

The tine 18, as well as the arcuate prong 22a, provide shear support to the embodiment when mounted into the wallboard 36. The resulting configuration of the features of the embodiment securely mounts the device to the wallboard 36 without the use of tools other than the human hand. This final configuration is illustrated in FIG. 8.

Also shown in FIG. 8 is the load bearing shank 20 extending from the lower panel front face 42. The load bearing shank 20 is utilized for the purpose of suspending such household or office items not limited to shelving, pictures, frames, posters, racks, decorative items, window treatments, and operative devices such as clocks, speakers, and other electrical items.

The weight of such objects attached to the load bearing shank 20 creates a moment around the hinge connection 12. The moment fortes the tine 16 deeper into the wallboard 36. Unexpectedly, the moment also causes the device to flex about the hinge connection 12. The flexing action drives the arcuate prong 22a deeper into the wallboard 36. The combination of the forces results in a clamping or jaw-like action between the tine 18 and arcuate prong 22a which helps the embodiment to further grip the wallboard 36. The unique geometry of the embodiment which combines the clamping action, as well as providing shear support efficiently employs gravity to secure the device in place.

Due to the smooth penetrating action and small diameter of the tine 18 and arcuate prong 22a, the device is readily and easily removed from the wallboard 36 and does not require any tools for removal. The process for removal is a reverse of the installation procedure elaborated upon previously in this section.

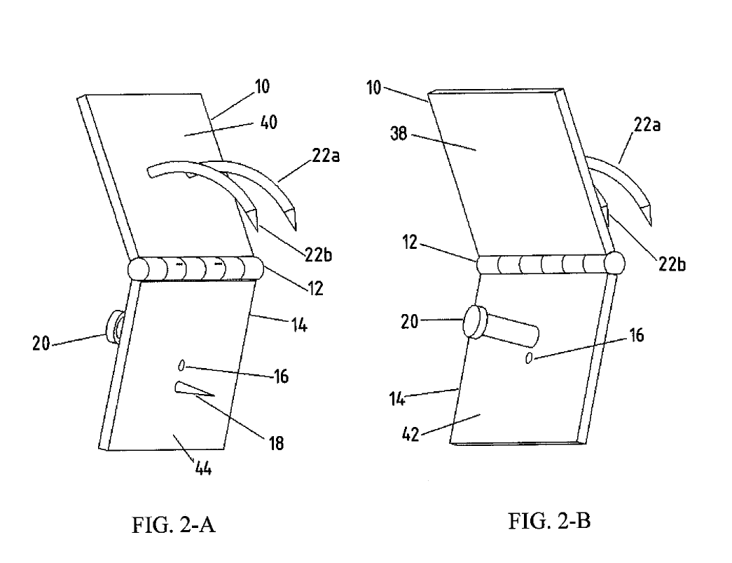

A perspective view of the rear side of an alternative embodiment with a secondary arcuate prong 22a is depicted in FIG. 2-A. A perspective view of the front side of an alternative embodiment with a secondary arcuate prong 22a is depicted in FIG. 2-B. Additional alternative embodiments could include numerous arcuate prongs at varying location on the panels. Alternative embodiments could also be manufactured with punch and lance procedures thereby creating the device and all features of the embodiment from a single common door/butt hinge.

The embodiment could be manufactured in a plethora of sizes as well as from various materials including but not limited to metal, plastic, etc. due to the simplistic design of the embodiment. The general clamping and securing action of the embodiment could be found useful in numerous area of interest other than wall anchors. Other areas of interest in which the embodiment or versions of the embodiment could be used include but are not limited to outdoor equipment such as rock climbing securements, medical devices, moorings, fasteners, etc.

What is claimed is:

1. A anchoring device for suspending objects from vertical walls, especially gypsum wallboards, comprising of:
a) an upper panel comprised of a flat front face, a flat rear face, and a bottom edge of predetermined size and thickness, and
b) a lower panel comprised of a flat front face, a flat rear face, and a top edge of predetermined size and thickness, and
c) a hinged connection exhibiting rotational movement capabilities joining said upper panel bottom edge to said lower panel top edge, and
d) a curved member of predetermined length extending perpendicularly from said rear face of said upper panel equipped with a piercing tip, said curved member exhibiting a radius of curvature equal to the distance said curved member is located from the hinged connection
e) a tine extending perpendicularly from said rear face of said lower panel equipped with a piercing tip, and
f) a load bearing shank of predetermined length extending perpendicularly from said front face of said lower panel located below said hinge connection and above said tine capable of supporting an object; said shank transferring said supported object's weight to said upper panel, said lower panel, and said hinged connection resulting in said upper panel and said lower panel rotating around said hinged connection creating a clamping moment force by said panels onto said wall; whereby a human can suspend an object from common wall material.

2. The anchoring device of claim 1 wherein said rear face of said upper panel exhibits multiples of said curved member of predetermined length and radii of curvature extending perpendicularly from said rear face of said upper panel.

3. A device for supporting objects on a wall comprising:
a) a first panel defining a front face, a rear face, and a bottom edge, said rear face defining a supporting surface for contact with the exterior surface of said wall;
b) a second panel defining a front face, a rear face, and a top edge, said rear face defining a supporting surface for contact with the exterior surface of said wall;
c) a connection joining said bottom edge of said first panel with said top edge of said second panel, said connection exhibiting rotational movement capabilities;
d) an elongated arcuate arm extending from said rear face of said first panel and adapted to pierce an aperture in said wall, said arcuate arm terminating in a distal point for penetrating, said arcuate arm exhibiting a radius of curvature equal to the distance between said arcuate arm and said connection;
e) an tine of predetermined length extending from said rear face of said second panel and adapted to pierce an aperture in said wall; and
f) an aperture of predetermined size extending through said second panel; and
g) a shank portion extending from said front face of said second panel located midway between said tine and said connection, said shank including a support area for receiving and carrying a portion of said object being supported where the weight of said object supported by said shank causes said first panel and said second panel to rotate around said joining connection resulting in a clamping force against said wall.

4. The device of claim 3 wherein said rear face of said first panel exhibits additional said elongated arcuate arm extending from said rear face of said first panel.

5. A method of securing an appurtenance to a wall, the wall having a wallboard, the wallboard having a thickness and comprising a gypsum core with sheathing material on an interior surface and an outer exposed surface, the appurtenance having an upright attachment position, a front side for facing away from the wall and a back side for facing the wall, the appurtenance having a wall confronting region on said back side, the method comprising the steps of:
providing a device with an upper panel of predetermined size and thickness defining a front and rear face, a lower panel of predetermined size and thickness defining a front and rear face, a connection exhibiting rotational movement capabilities joining an edge of said upper panel to an edge of said lower panel, a curved member of predetermined length extending perpendicularly from said rear face of said upper panel, said curved member exhibiting a radius of curvature equal to the distance between said curved member and said connection, said curved member terminating in a piercing tip, a tine extending perpendicularly from said rear face of said lower panel equipped with a piercing tip, a shank portion extending from said front face of said lower panel located midway between said tine and said connection capable of supporting appurtenances,
penetrating the outer sheathing material of the wall and then core of the wall with the piercing tip of the tine until the rear face of the lower panel makes contact with the outer sheathing material of the wall and rests flush against said outer sheathing of wall,
rotating the upper panel around the connection joining the upper panel to the lower panel until the piercing tip of the curved member extending from the rear face of the upper panel penetrates the outer sheathing and then core of the wall until the rear face of the upper panel makes contact with the outer sheathing of the wall and rests flush against the outer sheathing of the wall,
suspending said appurtenance from the load bearing shank extending from the front face of the lower panel, said shank transferring said appurtenance's weight to said upper panel, said lower panel, and said hinged connection resulting in said upper panel and said lower panel rotating around said hinged connection creating a clamping moment force by said panels onto said wall.

6. The method of claim 5 further comprising the step of fixing multiples of the curved member of predetermined length and radius of curvature and piercing tip from the rear face of the upper panel.
